(19) United States
(12) Patent Application Publication
(10) Pub. No.: US 2009/0140986 A1
(43) Pub. Date: Jun. 4, 2009

(54) METHOD, APPARATUS AND COMPUTER PROGRAM PRODUCT FOR TRANSFERRING FILES BETWEEN DEVICES VIA DRAG AND DROP

(75) Inventors: Leo Mikko Johannes Karkkainen, Helsinki (FI); Jukka Antero Parkkinen, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/948,138

(22) Filed: Nov. 30, 2007

(51) Int. Cl. G06F 3/041

(52) U.S. Cl. 345/173

(57) ABSTRACT

A method, apparatus, system and computer program product are provided for transferring files stored on a source device to a target device by dragging and dropping the file from the source device touchscreen to the target device touchscreen. When the source device detects that the user has dragged the file to the edge, or other predefined location, of the source device touchscreen, the source device will automatically identify and establish a connection with the target device. Once the connection has been established, an image or icon associated with the file can be transferred to the target device, so that the user of the target device can indicate the location to which the file should be transferred by dragging the icon to that location. Once the target device user drops the icon at the predefined location, the file can be transferred to that location.

### FIELD

Embodiments of the invention relate, generally, to transferring data and, in particular, to a technique for facilitating the transfer of data between electronic devices.

### BACKGROUND

Sharing pictures, songs, videos, games, and other types of information with friends, family, loved ones and colleagues has always been a desirable past time. Sharing work product, such as documents, presentations, spreadsheets, or the like, may also be desirable if not necessary in many instances. Advances in technology have greatly enhanced the capability of many electronic devices (e.g., cellular telephones, personal digital assistants (PDAs), personal computers (PCs), laptops, etc.) to capture, create, display and store this type of data. However, many devices still suffer from several limitations including, for example, the absence of a fast, easy way to transfer the data (i.e., objects or files including, for example, pictures, songs, videos, games, documents, presentations, spreadsheets, etc.) from one device to another.

Currently, in order to transfer an object or file from one device to another, a user may have to first establish a wired or wireless connection between the devices. Once connected, the user may further need to move the object or file to be transferred into an exchange folder or other transport application operating on the transferring device. The transport application may then transfer the object or file to an inbox of the receiving device. In order to open, render or otherwise execute the transferred object or file, the receiving device may be required to retrieve the object or file from the inbox and then transfer the object or file to the application capable of and responsible for rendering or otherwise executing the object or file. This process can be time consuming and requires an unnecessarily cumbersome number of steps.

Based on the foregoing, a need exists for a simple and efficient way to transfer files from one device to another so that the user of the receiving device has immediate access to the file.

### BRIEF SUMMARY

In general, embodiments of the present invention provide an improvement by, among other things, enabling a user to transfer objects or files stored on one device (hereinafter the “source device”) to another device (hereinafter the “target device”) by simply dragging and dropping the object or file from the source device touchscreen to the target device touchscreen. In particular, according to one embodiment, a user may select the object or file he or she would like to transfer to another device by touching the source device touchscreen at or near the location at which an image or icon associated with the object or file is displayed. He or she may then drag the image or icon and, by extension, the object or file, to the edge of the source device touchscreen, or some other predefined location. In response to detecting this dragging gesture, according to one embodiment, the source device may automatically search for the intended recipient of the dragged object or file (i.e., the target device) by broadcasting a message requesting the identity of the target device.

At or about the same time, a user, which may or may not be the same user as that of the source device, may continue the dragging gesture on the target device by touching the target device touchscreen at or near the edge, or some other predefined location, and moving towards the center of the touchscreen while continuously applying pressure. In response to receiving the broadcast message from the source device and detecting the continued gesture, the target device may respond to the source device identifying itself as the intended recipient of the object or file. The source device may then establish a connection with the target device enabling the image or icon associated with the object or file to be transferred to the target device and displayed on the target device touchscreen. The user of the target device may then drag the image or icon to the location to which he or she would like the object or file to be transferred (e.g., to an application operating on the target device or simply to the user space of the target device) and then drop the image or icon at that location. The source device may then transfer the object or file to the identified location on the target device via the previously established connection.

In accordance with one aspect, a method is provided for transferring objects or files from a source device to a target device. In one embodiment, the method may include: (1) displaying an image associated with a file at a first location on a touchscreen of a source electronic device; (2) receiving a tactile input proximate the first location; (3) detecting a movement of the tactile input from the first location to a second location proximate an edge of the touchscreen; (4) automatically identifying, in response to detecting the movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and (5) establishing a connection with the target electronic device, such that the file can be transferred to the target electronic device via the established connection.

In accordance with another aspect, an apparatus is provided for transferring objects or files from a source device to a target device. In one embodiment, the apparatus may comprise a processor configured to: (1) cause an image associated with a file to be displayed at a first location on a touchscreen of a source electronic device; (2) receive an indication of a tactile input proximate the first location; (3) detect a movement of the tactile input from the first location to a second location proximate an edge of the touchscreen; (4) automatically identify, in response to the detected movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and (5) establish a connection with the target electronic device, such that the file can be transferred to the target electronic device via the established connection.

In accordance with yet another aspect, a computer program product is provided for transferring objects or files from a source device to a target device. The computer program product contains at least one computer-readable storage medium having computer-readable program code portions stored therein. The computer-readable program code portions of one embodiment may include: (1) a first executable portion for causing an image associated with a file to be displayed at a first location on a touchscreen of a source electronic device; (2) a second executable portion for receiving a tactile input proximate the first location; (3) a third executable portion for detecting a movement of the tactile input from the first location to a second location proximate an edge of the touchscreen; (4) a fourth executable portion for automatically identifying, in response to detecting the movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and (5) a fifth executable portion for establishing a connection with the target electronic device, such that the file can be transferred to the target electronic device via the established connection.

In accordance with one aspect, an apparatus is provided for transferring objects or files from a source device to a target device. In one embodiment, the apparatus may include a processor configured to: (1) cause an image associated with a file to be displayed at a first location on a touchscreen of a source electronic device; (2) receive an indication of a tactile input proximate the first location; (3) detect a movement of the tactile input from the first location to a second predefined location; (4) automatically identify, in response to the detected movement, a target electronic device to which the file can be transferred; (5) establish a connection with the target electronic device; (6) transfer the image associated with the file to the target electronic device, such that the image can be displayed on a touchscreen of the target electronic device; and (7) transfer the file to a predefined location on the target electronic device, said predefined location identified by a user of the target electronic device by dragging the image displayed on the target electronic device touchscreen to the predefined location.

In accordance with another aspect, a system is provided for establishing a connection between two electronic devices. In one embodiment, the system may include a first and a second electronic device. The first electronic device of the system may be configured to receive an indication of a tactile input proximate a first location on a touchscreen of the first electronic device and to detect a movement of the tactile input from the first location to a second location on the touchscreen, wherein the movement forms a predefined pattern. The second electronic device may similarly be configured to receive an indication of a tactile input proximate a first location on a touchscreen of the second electronic device and to detect a movement of the tactile input from the first location to a second location on the touchscreen, wherein the movement forms the predefined pattern. In response to the first and second electronic devices detecting the movement forming the predefined pattern, the first electronic device of this embodiment may be further configured to establish a connection with the second electronic device.

In accordance with another aspect, an apparatus is provided for transferring objects or files from a source device to a target device. In one embodiment, the apparatus may include: (1) means for displaying an image associated with a file at a first location on a touchscreen of a source electronic device; (2) means for receiving an indication of a tactile input proximate the first location; (3) means for detecting a movement of the tactile input from the first location to a second location proximate an edge of the touchscreen; (4) means for automatically identifying, in response to the detected movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and (5) means for establishing a connection with the target electronic device, such that the file can be transferred to the target electronic device via the established connection.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating how an object or file may be transferred from one device to another in accordance with an embodiment of the present invention;

FIG. 2 is a schematic block diagram of a mobile station capable of operating in accordance with an embodiment of the present invention;

FIG. 3 is a flow chart illustrating the transfer of objects or files between electronic devices in accordance with embodiments of the present invention;

FIGS. 4A-4C illustrate the process that may be undergone in order to identify a target device to whom to transfer an object or file in accordance with embodiments of the present invention; and

FIG. 5 is a block diagram illustrating how a connection can be established between two devices in accordance with an embodiment of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide a method, apparatus, computer program product and system for transferring objects or files (e.g., any object, collection of objects, applications, or the like, including, for example, audio and/or video files, Word or PDF documents, Excel spreadsheets, PowerPoint presentations, games or similar applications, etc.) from a source device to a target device by simply dragging and dropping the object or file from the source device touchscreen to the target device touchscreen. In particular, according to one embodiment, when a user operating the source device (e.g., cellular telephone, personal digital assistant (PDA), laptop, personal computer (PC), pager, etc.) wishes to transfer an object or file stored on the source device to a target device, he or she can first select the object or file by touching the source device touchscreen using a finger, stylus or other similar device, proximate the location at which the image or icon associated with the object or file is displayed. The user can then drag the image or icon to the edge of the source device touchscreen by moving his or her finger, stylus, or other similar device, to the edge, or some other predefined location, while continuously applying pressure to the source device touchscreen.

At or about the same time, a user of the target device, which may or may not be the same user as that of the source device, may continue the dragging gesture on the target device. In other words, the user of the target device may touch the target device touchscreen at the edge, or some other predefined location, of the touchscreen using his or her finger, stylus, or other similar device, and then move the finger, stylus or other similar device away from the edge, or other predefined location, toward the center of the touchscreen, while continuously applying pressure to the touchscreen.

When the source device detects that the user has dragged the image or icon, and thereby the object or file associated with the image or icon, to the edge of the touchscreen, the source device may automatically search for the target device to which the file is to be transferred. In order to identify the target device, according to one embodiment, the source device may broadcast a message requesting the identity of the target device. In response to receiving the broadcast and detecting the above-described gesture on the target device touchscreen, the target device may respond to the source device identifying itself as the intended recipient of the file. Once the target device has been identified, the source and target devices may establish a connection through which the source device can first transfer the image or icon associated with the file or object, such that the image or icon can be displayed on the target device touchscreen. After the image or icon has been displayed, the target device user can drag and drop the image or icon to a location to which the user desires the object or file to be transferred. Once the image or icon has been dropped at the desired location, the source device can then transfer the object or file to that location using the previously established connection.

### Overall System and Mobile Device:

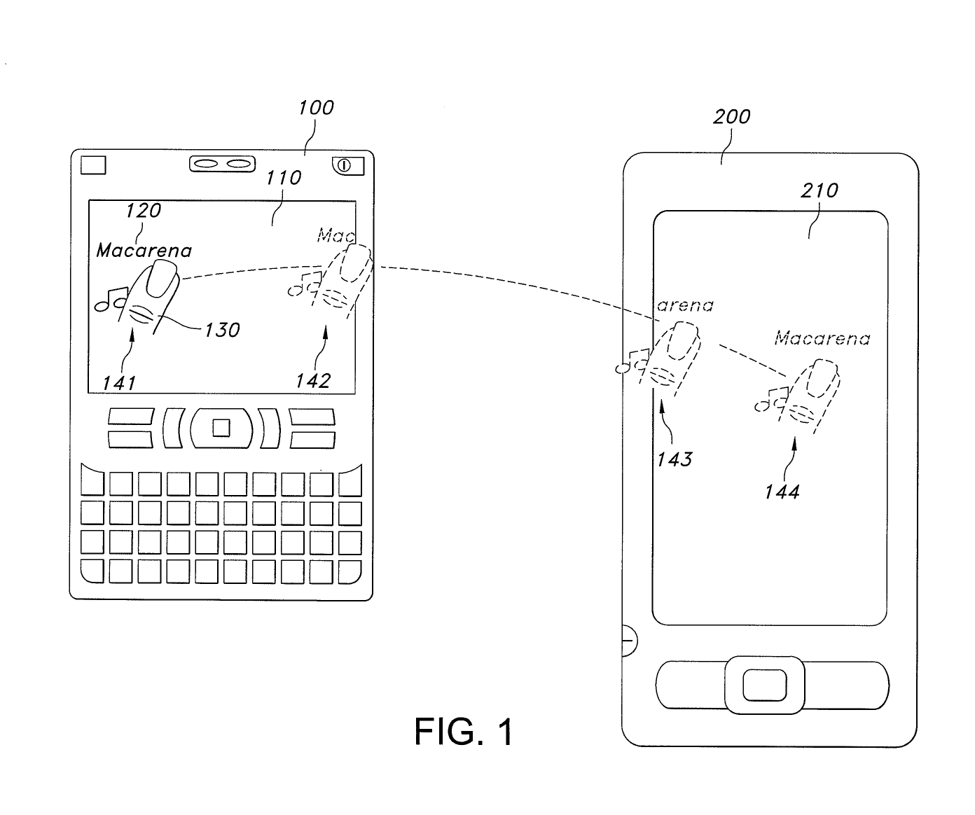

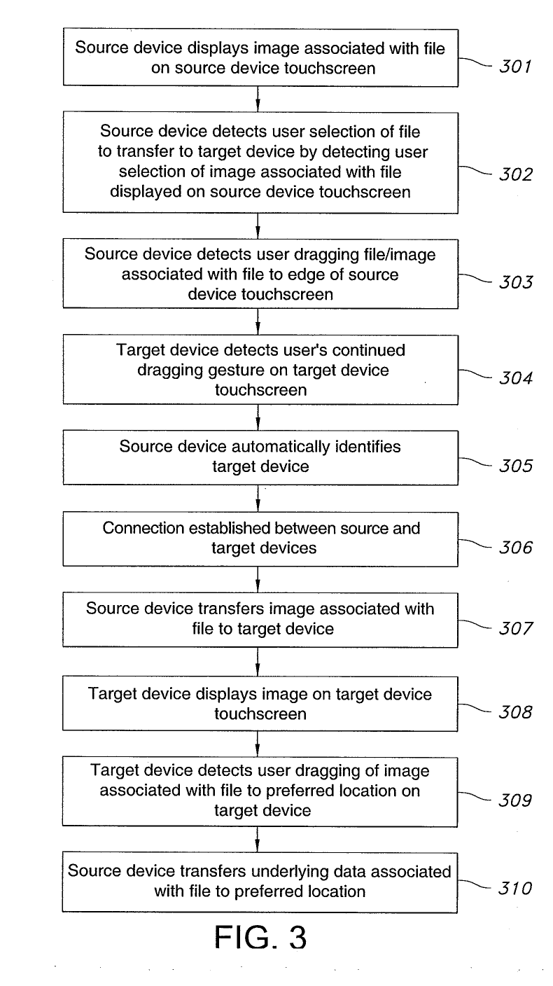

Referring to FIG. 1, an illustration of one type of system that would benefit from embodiments of the present invention is provided. As shown, the system may include a source device 100 and a target device 200, each configured to transfer and receive one or more objects or files to or from the other device in the manner described herein. In particular, the source and target devices 100, 200 may include any electronic device capable of storing, sending and receiving various types of data including, for example, documents, presentations, spreadsheets, audio files, video files, games or other similar applications, or the like. These devices may include, for example, cellular telephones, personal digital assistants (PDAs), laptops, personal computers (PCs), pagers, and the like. As shown, the source and target devices 100, 200 need not be, but may be, the same type of device. While the system shown in FIG. 1 includes only two devices, as one of ordinary skill in the art will recognize, embodiments of the invention are not limited to the transferring of an object or file from a single device to another, single device. In contrast, as is discussed in more detail below with regard to FIG. 3, the source device 100 may transfer an object or file to multiple target devices 200. Similarly, the target device 200 may receive objects or files from multiple source devices 100.

As shown, the source and target devices 100, 200 may each include a touch-sensitive display screen or touchscreen 110 and 210, on which various images or icons representing objects or files stored on the device can be displayed. For example, in one embodiment, an icon associated the song “Marcarena” 120, which is stored in memory on the source device 100, may be displayed on the source device touchscreen 110. A user may use his or her finger 130 to touch the source device touchscreen 110 at or near the location at which this icon 120 is displayed 141 in order to select the song.

According to embodiments of the invention, when the user drags the icon 120 to the edge 142 of the source device touchscreen 110, or to some other predefined location, the source device 100 may interpret this gesture as an indication that the user would like to transfer the song to another device. Similarly, when the target device 200 detects the placement of a user's finger on the edge 143, or some other predefined location, of the target device touchscreen 210 and movement of the finger to another location 144 on the target device touchscreen 210 that is away from the edge 143, the target device may interpret this gesture as an indication that the user would like to receive an object or file that is being transferred from another device. As is discussed in more detail below with regard to FIG. 3, either or both of the source or target device 100, 200 may then search for the other device, establish a connection, and then facilitate first the transfer of the icon 120 to the target device 200 for display on the target device touchscreen 210 and then the transfer of the song itself, once the user of the target device has identified the preferred location for the transfer by dragging the icon 120 to that location.

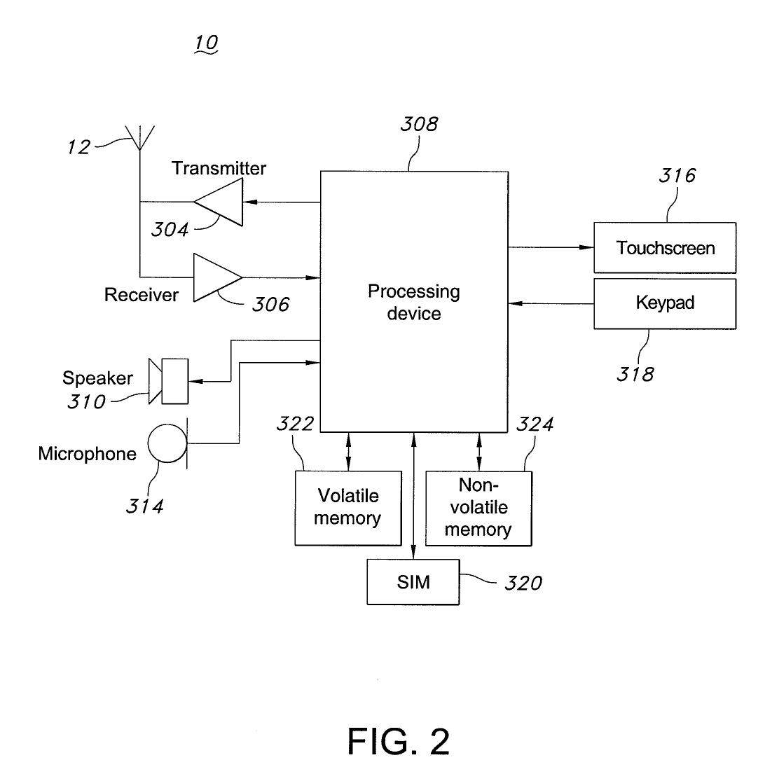

Reference is now made to FIG. 2, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 12, the mobile station 10 includes a transmitter 304, a receiver 306, and means, such as a processing device 308, e.g., a processor, controller or the like, that provides signals to and receives signals from the transmitter 304 and receiver 306, respectively, and that performs the various other functions described below including, for example, the functions relating to transferring objects or files to another electronic device in response to detecting a dragging of the object or file to the edge of a touchscreen 316 associated with the mobile station by the user of the mobile station.

As discussed in more detail below with regard to FIG. 3, in one embodiment wherein the mobile station 10 comprises a source device 100, the processor 308 may be configured to cause an image 120 associated with a file stored on the mobile station 10 to be displayed at a first location 141 on the touchscreen 316, to receive an indication of a tactile input proximate the first location 141, and further to detect a movement of the tactile input from the first location 141 to a second predefined location 142, such as proximate the edge of the touchscreen 316. The processor 308 may be further configured, in response to detecting the movement, to automatically identify a target device 200, or a device to which the file associated with the image is to be transferred, and to then establish a connection with the target device 200, such that the file can be transferred via the established connection. Alternatively, where the mobile station 10 comprises a target device 200, the processor 308 may be configured to receive an indication of a tactile input proximate an edge 143, or other predefined location, of the touchscreen 316, as well as to detect a movement of the tactile input from the predefined location (e.g., edge 143) to another location 144 on the touchscreen 316. In response, the processor 308 may be further configured to broadcast a message identifying the target device as the intended recipient of a file. The processor 308 of the target device may further be configured to receive and display the image 120 associated with the file and thereafter to receive and save the file itself. As one of ordinary skill in the art will recognize, the mobile station 10 may be configured as both a source and a target device and, therefore, the processor 308 may be configured to perform all of the functions described above.

As one of ordinary skill in the art would recognize, the signals provided to and received from the transmitter 304 and receiver 306, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a touch-sensitive display or touchscreen 316, all of which are coupled to the controller 308. The user input interface, which allows the mobile device to receive data, can comprise any of a number of devices allowing the mobile device to receive data, such as a keypad 318, a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory can also store content. The memory may, for example, store computer program code for an application and other computer programs. For example, in one embodiment of the present invention, the memory may store computer program code for causing an image 120 associated with a file stored on the mobile station 10 to be displayed at a first location 141 on the touchscreen 316, receiving an indication of a tactile input proximate the first location 141, and further detecting a movement of the tactile input from the first location 141 to a second predefined location 142, such as proximate the edge of the touchscreen 316. The memory may further store computer program code for, in response to detecting the movement, automatically identifying a target device 200, or a device to which the file associated with the image is to be transferred, and then establishing a connection with the target device 200, such that the file can be transferred via the established connection. Alternatively, or in addition, wherein the mobile station 10 comprises a target device 200, the memory may store computer program code for receiving an indication of a tactile input proximate an edge 143, or other predefined location, of the touchscreen 316, as well as detecting a movement of the tactile input from the predefined location (e.g., edge 143) to another location 144 on the touchscreen 316. The memory may further store computer program code for, in response to detecting the movement, broadcasting a message identifying the target device as the intended recipient of a file, receiving and displaying the image 120 associated with the file, and thereafter receiving and saving the file itself.

The method, apparatus, computer program product and system of embodiments of the present invention are primarily described in conjunction with mobile communications applications. It should be understood, however, that the method, apparatus, computer program product and system of embodiments of the present invention can be utilized in conjunction with a variety of other applications, both in the mobile communications industries and outside of the mobile communications industries. For example, the method, apparatus, computer program product and system of embodiments of the present invention can be utilized in conjunction with wireline and/or wireless network (e.g., Internet) applications.

Method of Establishing a Connection and Transferring Files between Devices

Referring now to FIG. 3, the operations are illustrated that may be taken in order to transfer an object or file from a source to a target device using the drag and drop method described herein. As shown, the process may begin at Block 301 when an image or icon associated with an object or file stored on the source device is displayed on the source device touchscreen (i.e., the processor, or similar means, operating on the source device causes the image or icon to be displayed). As noted above, the objects or files may include any data stored on the source device that is capable of being transmitted including, for example, text files, audio files, video files, multimedia files, applications, or the like. Where, for example, the file is stored in the “user space” of the source device or, in other words, is not affiliated with any programs or folders saved on the source device (e.g., the equivalent of saving the object or file to the desktop of a PC), the image or icon associated with the file may be automatically displayed on the source device touchscreen. In contrast, where, for example, the file is stored in association with an application or one or more folders, a user may be required to search for the file or object within the programs or folders in order to display the corresponding image or icon.

Once displayed, the user can then select the file to transfer to the target device by touching the source device touchscreen using a finger, stylus or other similar device at or near the location at which the image or icon is displayed. (Block 302). The source device, and in particular, the processor or similar means operating on the source device, may detect the tactile input and determine its location via any number of techniques that are known to those of ordinary skill in the art. For example, the touchscreen may comprise two layers that are held apart by spacers and have an electrical current running therebetween. When a user touches the touchscreen, the two layers may make contact causing a change in the electrical current at the point of contact. The electronic device may note the change of the electrical current, as well as the coordinates of the point of contact. Alternatively, wherein the touchscreen uses a capacitive, as opposed to a resistive, system to detect tactile input, the touchscreen may comprise a layer storing electrical charge. When a user touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen interface may be configured to receive an indication of an input in the form of a touch event at the touch screen display. As suggested above, the touch event may be defined as an actual physical contact between a selection object (e.g., a finger, stylus, pen, pencil, or other pointing device) and the touchscreen display. Alternatively, a touch event may be defined as bringing the selection object in proximity to the touchscreen display (e.g., hovering over an object or approaching an object within a predefined distance).

Once selected, the user can, at Block 303, drag the image, and by extension the file, to a predefined location on the source device touchscreen, such as the edge of the source device touchscreen, by moving his or her finger, stylus or other similar device to the edge, or other predefined location, of the source device touchscreen while continuously applying pressure. The processor or similar means operating on the source device may detect this movement using, for example, any of the above-described techniques for detecting a tactile input and determining its location, and interpret this movement as an indication that the user wishes to transfer the file to another device. In one embodiment, the processor, or similar means, may further detect the velocity at which the movement is performed. The processor may thereafter compare the velocity to some predefined velocity, wherein only if the velocity exceeds the predefined velocity, will the processor, or similar means, interpret the movement as an indication that the user wishes to transfer the file.

Shortly thereafter, a user of the target device may continue the dragging gesture on the target device touchscreen. (Block 304). In particular, the user may place his or her finger, stylus or other similar device at or near the edge, or other predefined location, of the target device touchscreen and then move his or her finger, stylus or other similar device away from the predefined location (e.g., edge), while continuously applying pressure. The target device and, in particular, the processor or similar means operating on the target device, may detect the tactile input and movement using any of the methods described above with regard to the source device. In addition, as discussed above with regard to the source device, the target device processor may similarly detect the velocity of the movement and interpret either the movement itself or the movement and its velocity as an indication that the user of the target device wishes to receive a file that is being transferred from another device.

In one embodiment, the two devices (i.e., the source and target devices) may be positioned close enough to one another to enable the same user to perform the dragging gesture on both the source and target device touchscreens. Alternatively, the devices may be separated by a larger distance resulting in different users being required to perform the dragging gesture on their respective devices. In addition, while the above description refers to only a single target device, as one of ordinary skill in the art will recognize, more than one target device may exist for receiving a file transmitted from the source device. In this embodiment, several users may substantially simultaneously perform the dragging gesture on their respective “target” devices, causing each of the devices (i.e., the processors on those devices) to assume that their respective users wish to receive a file being transferred.

Returning to FIG. 3, the source device (i.e., the processor or similar means operating on the source device), in response to detecting that the user has dragged a file to the edge (or other predefined location) of the touchscreen and, in one embodiment, has done so at a particular velocity, will automatically identify the target device (or devices), or the intended recipient of the file. In particular, at least three alternatives exist for identifying the target device. As one of ordinary skill in the art will recognize, however, other alternatives may likewise exist that do not depart from the spirit and scope of embodiments of the invention, and embodiments of the invention are, therefore, not limited to those alternatives disclosed herein.

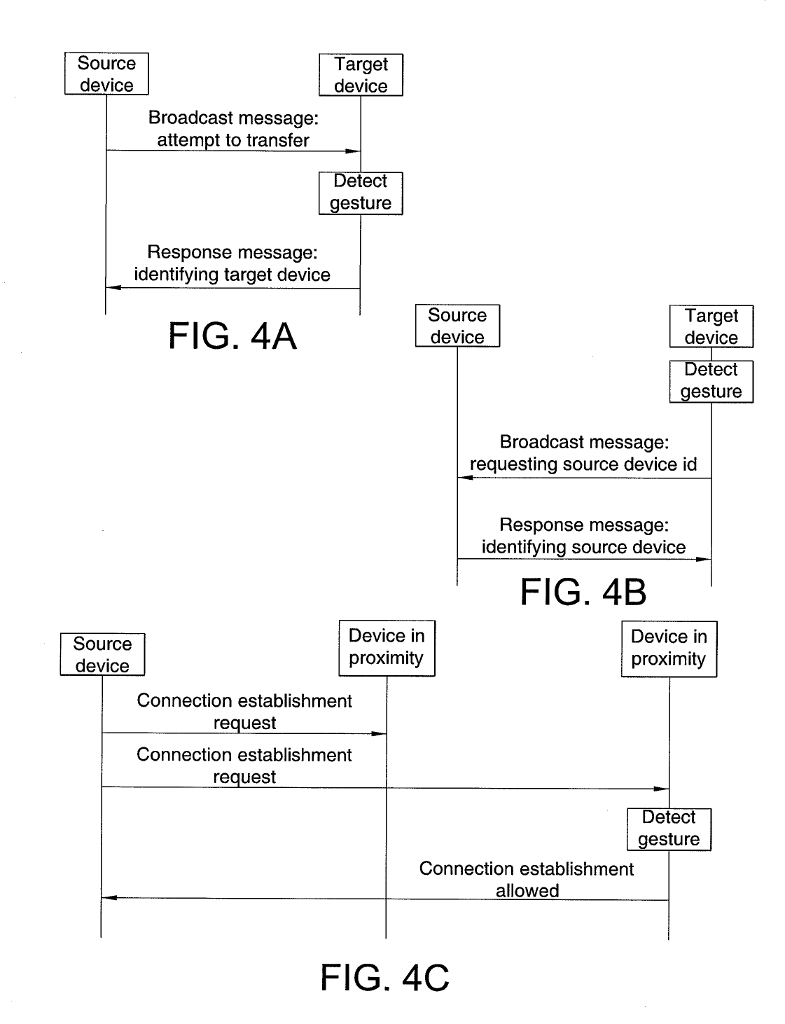

First, according to one embodiment, shown in FIG. 4A, the source device, and in particular the processor or similar means operating on the source device, may broadcast a message indicating that it is attempting to transfer a file. The message may be broadcast using any wireless network including, for example, a wireless local area network (WLAN), wireless wide area network (WWAN), wireless metropolitan area network (WMAN), or wireless personal area network (WPAN), and any known or not yet known communication protocol including, for example, General Packet Radio Service (GPRS), Enhanced Data GSM Environment (EDGE), Universal Mobile Telephone System (UMTS), or the like, as well as any one of various wireless networking techniques, such as radio frequency (RF), Bluetooth (BT), infrared (IrDA), or the like. In response to receiving the broadcast message, and to detecting the dragging gesture described above, the target device (i.e., the processor or similar means operating on the target device) may then send a response message to the source device identifying itself as the intended recipient of the file.

Second, in another embodiment shown in FIG. 4B, the source device (i.e., the processor or similar means operating on the source device), rather than broadcasting a message requesting the identity of the target device, may simply begin listening for messages from other devices identifying themselves as the target device. In this embodiment, the processor or similar means operating on the target device (or devices) may, in response to detecting the dragging gesture on the target device touchscreen, begin broadcasting a message, via any of the methods described above, requesting the identity of the device from which a file is attempting to be transferred (i.e., the source device). When the source device receives the broadcast message, it may either immediately establish a connection with the target device (e.g., as described below) or transmit a response message to the target device identifying itself as the source device (as shown in FIG. 4B).

Finally, according to yet another embodiment shown in FIG. 4C, the processor or similar means operating on the source device may determine which devices are in proximity of the source device, and assume that each device within proximity is a target device. In this embodiment, the source device may then attempt to establish a connection with each of the devices identified (see Block 306 below), whereupon only the devices that detected the dragging gesture (i.e., the placement of a user's finger, stylus, or similar device on the edge of the touchscreen and movement away from the edge) will allow the connection to be established.

Once the target device has been identified, a connection or communication channel can then be established between the two devices using, for example, RF, BT, IrDA, or a similar wireless networking technique, depending upon the distance between the two devices and the capabilities of those devices. (Block 306). The devices may then negotiate over the communication channel whether the target device has the capabilities to receive and render, or otherwise execute, the file being transferred from the source device, as well as how the file will ultimately be transferred. For example, if the source device is attempting to transfer a video file, it may be necessary to first determine whether the target device has an application capable of playing the video file (e.g., QuickTime, Window Media Player, etc.).

Using the established connection, the source device can then transfer the image or icon associated with the file to the target device over the established connection or communication channel. (Block 307). Upon receipt, the target device may, at Block 308, display the image or icon on the target device touchscreen, so that the user, at Block 309, can select, drag and drop the image or icon to the location to which he or she would like the corresponding file to be transferred. As one of ordinary skill in the art will recognize, this may involve simply dropping the image or icon within the “user space” (i.e., not associated with any application or folder operating or stored on the device), or it may involve dragging the image or icon to a specific application capable of rendering or executing the file. For example, referring back to FIG. 1, assuming the file to be transferred is an audio file (e.g., an MPEG-1 Audio Layer 3 (MP3) file) of the song “Macarena,” the user may drop the icon associated with the song on an MP3, or similar, player operating on the target device.

The processor or similar means operating on the target device may detect the location at which the image or icon was dropped and then communicate that information to the source device using the established connection, so that the source device (i.e., the processor or similar means operating on the source device) can, at Block 310, transfer the file to the designated location using an applicable protocol (e.g., file transfer, streaming, etc.). In one embodiment, where the file is transferred to a specific application capable of rendering or executing the file (instead of the user space), the source device, and in particular a processor or similar means operating on the source device, may cause the application to automatically render or execute the file upon receipt. For example, the MP3 player may be instructed to begin playing Macarena once it has received the MP3.

While not shown, if, after establishing the connection with the source device and receiving and displaying the icon associated with the file to be transferred, the target device (i.e., the processor or similar means operating on the target device) does not detect a tactile input on the target device touchscreen at or near the location at which the icon is displayed and/or a movement of that tactile input, the target device may, after a certain period of time, delete the icon from the target device touchscreen. In this embodiment, the target device may assume after the designated period of time has lapsed, that the user of the target device is not interested in receiving the file the source device is attempting to transfer.

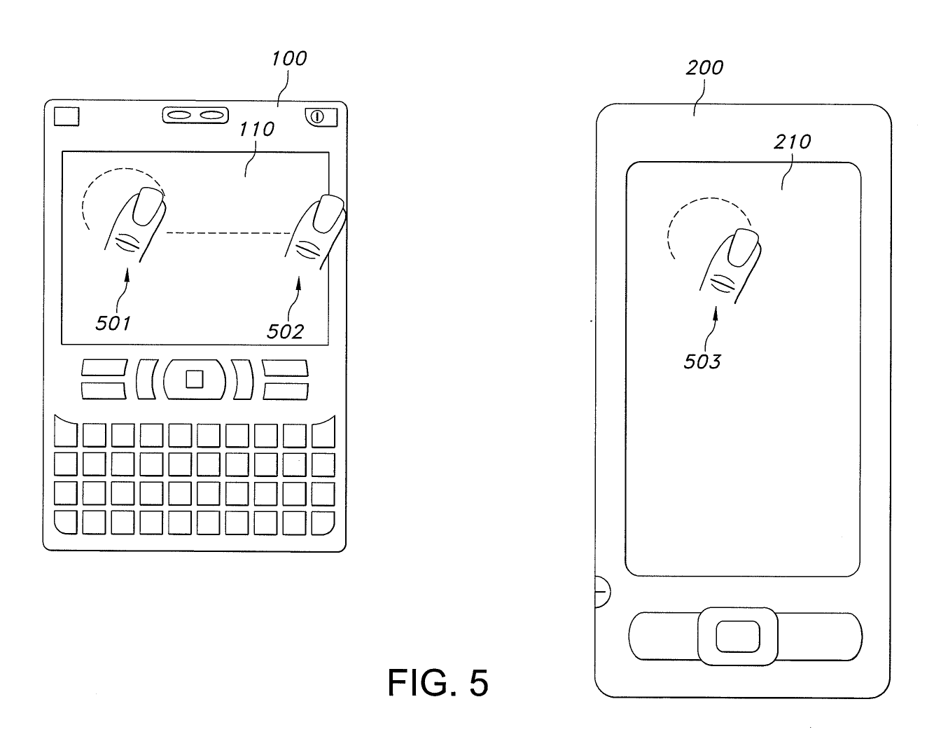

In some instances a user may desire to establish a connection between two electronic devices without necessarily wanting to immediately transfer objects or files from one device to the other. According to another embodiment of the present invention illustrated in FIG. 5, this may be done by duplicating a predefined gesture or pattern, such as a circle, square, question or exclamation mark, star, or the like, on the touchscreen of both devices. In particular, a user of a first device 100 may use his or her finger, stylus, or other similar device, to form a circle, or other pattern, on the touchscreen 110 of his or her device 100 (see 501), a movement which the device 100 (i.e., the processor or similar means operating on the device) may detect using any of the methods described above. The user may then drag his or her finger to the edge of the touchscreen 110 (see 502). A user of the second device 200, who may or may not be the same as the user of the first device 100, may then repeat substantially the same gesture or pattern on the touchscreen 210 of the second device 200 (see 503). In response to the duplication of this gesture or pattern on the touchscreen of both devices, either or both devices may then search for the device with which to connect, for example, in any of the manners described above with regard to FIGS. 4A through 4C. Once identified, the devices may establish a connection or communication channel using, for example, RF, BT, IrDA, or a similar wireless networking technique depending upon the distance between the two devices and the capability of those devices.

### CONCLUSION

As described above and as will be appreciated by one skilled in the art, embodiments of the present invention may be configured as a method, apparatus or system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 308 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 308 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
displaying an image associated with a file at a first location on a touchscreen of a source electronic device;
receiving a tactile input proximate the first location;
detecting a movement of the tactile input from the first location to a second location proximate an edge of the touchscreen;
automatically identifying, in response to detecting the movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and
establishing a connection with the target electronic device, such that the file can be transferred to the target electronic device via the established connection.

2. The method of 1 further comprising:
transferring the image associated with the file to the target electronic device, such that the image can be displayed on a touchscreen of the target electronic device; and
transferring the file to a predefined location on the target electronic device, said predefined location identified by a user of the target electronic device by dragging the image displayed on the target electronic device touchscreen to the predefined location.

3. The method of claim 1 further comprising:
determining a velocity of the movement of the tactile input from the first location to the second location, wherein the target electronic device is only identified when the velocity exceeds a predefined threshold.

4. The method of claim 1, wherein automatically identifying a target electronic device comprises:
broadcasting a message indicating that the source electronic device is attempting to transfer a file; and
receiving a response from the target electronic device identifying the target electronic device as the intended recipient of the file, said target electronic device having received the broadcast message and detected a tactile input proximate an edge of a touchscreen of the target electronic device and a movement of the tactile input from the edge of the touchscreen to another location on the touchscreen.

5. The method of claim 1, wherein automatically identifying a target electronic device comprises:
identifying one or more electronic devices in proximity of the source electronic device.

6. The method of claim 5, wherein establishing a connection with the target electronic device comprises:
attempting to establish a connection with respective electronic devices identified as in proximity of the source electronic device;
receiving a message from at least one of the one or more electronic devices identifying the at least one electronic device as the intended recipient of the file, said at least one electronic device having detected a tactile input proximate an edge of a touchscreen of the electronic device and a movement of the tactile input from the edge of the touchscreen to another location on the touchscreen; and
establishing a connection with the at least one electronic device from which the message was received.

7. The method of claim 1, wherein automatically identifying a target electronic device comprises:
receiving a message from the target electronic device identifying the target electronic device as the intended recipient of the file, said target electronic device having detected a tactile input proximate an edge of a touchscreen of the target electronic device and a movement of the tactile input from the edge of the touchscreen to another location on the touchscreen; and
transmitting a message to the target electronic device identifying the source electronic device as the sender of the file.

8. An apparatus comprising:
a processor configured to:
cause an image associated with a file to be displayed at a first location on a touchscreen of a source electronic device;
receive an indication of a tactile input proximate the first location;
detect a movement of the tactile input from the first location to a second location proximate an edge of the touchscreen;
automatically identify, in response to the detected movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and
establish a connection with the target electronic device, such that the file can be transferred to the target electronic device via the established connection.

9. The apparatus of 8, wherein the processor is further configured to:
transfer the image associated with the file to the target electronic device, such that the image can be displayed on a touchscreen of the target electronic device; and
transfer the file to a predefined location on the target electronic device, said predefined location identified by a user of the target electronic device by dragging the image displayed on the target electronic device touchscreen to the predefined location.

10. The apparatus of claim 8, wherein the processor is further configured to:
determine a velocity of the movement of the tactile input from the first location to the second location, wherein the target electronic device is only identified when the velocity exceeds a predefined threshold.

11. The apparatus of claim 8, wherein in order to automatically identify a target electronic device, the processor is further configured to:
broadcast a message indicating that the source electronic device is attempting to transfer a file; and
receive a response from the target electronic device identifying the target electronic device as the intended recipient of the file, said target electronic device having received the broadcast message and detected a tactile input proximate an edge of a touchscreen of the target electronic device and a movement of the tactile input from the edge of the touchscreen to another location on the touchscreen.

12. The apparatus of claim 8, wherein in order to automatically identify a target electronic device, the processor is further configured to:
identify one or more electronic devices in proximity of the source electronic device.

13. The apparatus of claim 12, wherein in order to establish a connection with the target electronic device, the processor is further configured to:
attempt to establish a connection with respective electronic devices identified as in proximity of the source electronic device;
receive a message from at least one of the one or more electronic devices identifying the at least one electronic device as the intended recipient of the file, said at least one electronic device having detected a tactile input proximate an edge of a touchscreen of the electronic device and a movement of the tactile input from the edge of the touchscreen to another location on the touchscreen; and
establish a connection with the at least one electronic device from which the message was received.

14. The apparatus of claim 8, wherein in order to automatically identify a target electronic device, the processor is further configured to:
receive a message from the target electronic device identifying the target electronic device as the intended recipient of the file, said target electronic device having detected a tactile input proximate an edge of a touchscreen of the target electronic device and a movement of the tactile input from the edge of the touchscreen to another location on the touchscreen; and
transmit a message to the target electronic device identifying the source electronic device as the sender of the file.

15. A computer program product comprising at least one computer-readable storage medium having computer-readable program code portions stored therein, the computer-readable program code portions comprising:
a first executable portion for causing an image associated with a file to be displayed at a first location on a touchscreen of a source electronic device;
a second executable portion for receiving a tactile input proximate the first location;
a third executable portion for detecting a movement of the tactile input from the first location to a second location proximate an edge of the touchscreen;
a fourth executable portion for automatically identifying, in response to detecting the movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and
a fifth executable portion for establishing a connection with the target electronic device, such that the file can be transferred to the target electronic device via the established connection.

16. The computer program product of 15 further comprising:
a sixth executable portion for transferring the image associated with the file to the target electronic device, such that the image can be displayed on a touchscreen of the target electronic device; and
a seventh executable portion for transferring the file to a predefined location on the target electronic device, said predefined location identified by a user of the target electronic device by dragging the image displayed on the target electronic device touchscreen to the predefined location.

17. The computer program product of claim 15 further comprising:
a sixth executable portion for determining a velocity of the movement of the tactile input from the first location to the second location, wherein the target electronic device is only identified when the velocity exceeds a predefined threshold.

18. The computer program product of claim 15, wherein the fourth executable portion is further configured to:
broadcast a message indicating that the source electronic device is attempting to transfer a file; and
receive a response from the target electronic device identifying the target electronic device as the intended recipient of the file, said target electronic device having received the broadcast message and detected a tactile input proximate an edge of a touchscreen of the target electronic device and a movement of the tactile input from the edge of the touchscreen to another location on the touchscreen.

19. The computer program product of claim 15, wherein the fourth executable portion is further configured to:
identify one or more electronic devices in proximity of the source electronic device.

20. The computer program product of claim 19, wherein the fifth executable portion is further configured to:
attempt to establish a connection with respective electronic devices identified as in proximity of the source electronic device;
receive a message from at least one of the one or more electronic devices identifying the at least one electronic device as the intended recipient of the file, said at least one electronic device having detected a tactile input proximate an edge of a touchscreen of the electronic device and a movement of the tactile input from the edge of the touchscreen to another location on the touchscreen; and
establish a connection with the at least one electronic device from which the message was received.

21. The computer program product of claim 15, wherein the fourth executable portion is further configured to:
receive a message from the target electronic device identifying the target electronic device as the intended recipient of the file, said target electronic device having detected a tactile input proximate an edge of a touchscreen of the target electronic device and a movement of the tactile input from the edge of the touchscreen to another location on the touchscreen; and
transmit a message to the target electronic device identifying the source electronic device as the sender of the file.

22. An apparatus comprising:
a processor configured to:
cause an image associated with a file to be displayed at a first location on a touchscreen of a source electronic device;
receive an indication of a tactile input proximate the first location;
detect a movement of the tactile input from the first location to a second predefined location;
automatically identify, in response to the detected movement, a target electronic device to which the file can be transferred;
establish a connection with the target electronic device;
transfer the image associated with the file to the target electronic device, such that the image can be displayed on a touchscreen of the target electronic device; and
transfer the file to a predefined location on the target electronic device, said predefined location identified by a user of the target electronic device by dragging the image displayed on the target electronic device touchscreen to the predefined location.

23. The apparatus of claim 22, wherein the processor is further configured to:
determine a velocity of the movement of the tactile input from the first location to the second location, wherein the target electronic device is only identified when the velocity exceeds a predefined threshold.

24. A system comprising:
a first electronic device configured to:
receive an indication of a tactile input proximate a first location on a touchscreen of the first electronic device; and
detect a movement of the tactile input from the first location to a second location on the touchscreen, wherein the movement forms a predefined pattern; and
a second electronic device configured to:
receive an indication of a tactile input proximate a first location on a touchscreen of the second electronic device; and
detect a movement of the tactile input from the first location to a second location on the touchscreen, wherein the movement forms the predefined pattern;
wherein the first electronic device is further configured to establish a connection with the second electronic device in response to the first and second electronic devices detecting the movement forming the predefined pattern.

25. The system of claim 24, wherein the first electronic device is further configured to:
detect a second movement of the tactile input from the second location on the touchscreen of the first electronic device to a third location proximate an edge of the touchscreen of the first electronic device, wherein the connection is established in response to further detecting the second movement.

26. An apparatus comprising:
means for displaying an image associated with a file at a first location on a touchscreen of a source electronic device;
means for receiving an indication of a tactile input proximate the first location;
means for detecting a movement of the tactile input from the first location to a second location proximate an edge of the touchscreen;
means for automatically identifying, in response to the detected movement, a target electronic device to which the file can be transferred, wherein the target electronic device is identified based at least in part on the target electronic device having detected a tactile input proximate an edge of a touchscreen of the target electronic device and a movement of the tactile input from the edge of the touchscreen to another location on the touchscreen; and
means for establishing a connection with the target electronic device, such that the file can be transferred to the target electronic device via the established connection.
